(19) United States
(12) Patent Application Publication
(10) Pub. No.: US 2008/0007984 A1
(43) Pub. Date: Jan. 10, 2008

(54) CONTROL CIRCUIT FOR POWER CONVERTER AND POWER CONVERTER USING THE SAME

(75) Inventor: Hsu-Min Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ITE TECH. INC., Hsinchu (TW)

(21) Appl. No.: 11/465,127

(22) Filed: Aug. 17, 2006

(30) Foreign Application Priority Data
Jul. 5, 2006 (TW) 95124441

(51) Int. Cl. H02M 7/5387

(52) U.S. Cl. 363/132

(57) ABSTRACT

A control circuit for a power converter and the power converter using the control circuit are provided. The power converter includes an energy-storing inductor. The control circuit includes a first switch component and a duty cycle control circuit. The first switch component is coupled to the energy-storing inductor to control the energy-storing inductor to store energy. The duty cycle control circuit receives a digital value and a clock signal to count enable times of the clock signal. When the enable times of the clock signal reach the digital value, the duty cycle control circuit controls the first switch component to suspend the energy-storing inductor from storing energy.

### CROSS-REFERENCE TO RELATED APPLICATION

This application claims the priority benefit of Taiwan application serial no. 95124441, filed Jul. 5, 2006. All disclosure of the Taiwan application is incorporated herein by reference.

### BACKGROUND OF THE INVENTION

1. Field of Invention

The present invention relates to a power converter. More particularly, the present invention relates to a control circuit for a power converter and a power converter using the control circuit.

2. Description of Related Art

As various information and communication equipments develop quickly, the design of the high efficient switching power supply has become a knowledge combining engineering and experience. The switching power supplier is used to convert power in many applications including computer, electronic ballast for illuminating and telecommunication equipment.

The circuit of conventional power supply, for example the conventional boost converter of FIG. 1, in order to increase the power converting efficiency, the value of the current IL flowing through the inductor L101 needs to be controlled, so in the conventional art, a current sensing circuit 102 is designed, so as to sense the value of the current IL flowing through the switch component SW 101 and output a sensing current Is proportional to the current IL accordingly. Next, the sensing current Is flows through the resistor R101 to generate the current sensing voltage Vsense. Finally, the current control circuit 103 controls the conducting time of the switch component SW101 according to the current sensing voltage Vsense and the feedback signal FB. In this manner, the value of the peak current of the inductor is controller, such that the amount of the energy stored by the inductor is controlled.

Although in the conventional art, FIG. 1 provides a circuit controlling the value of the current IL flowing through the inductor L101, the circuit needs to use a quite exact resistor R101, and the resistor must be used in the integrated circuit (IC) in a parallel connection manner, so a lot of area must be occupied in the IC. Further, the resistor R101 may result in the problems of power consumption and heating, and the rise of the temperature may result in the inaccuracy of the sensing voltage Vsense, so it is hard to control the value of the current IL of the inductor L101 exactly.

### SUMMARY OF THE INVENTION

Accordingly, an objective of the present invention is to provide a control circuit for the power converter, so as to exactly control the amount of the energy stored by the inductor and reduce the layout area of the chip.

Another objective of the present invention is to provide a power converter to reduce the power consumption, increase the whole efficiency and reduce the cost.

The present invention provides a control circuit for controlling a power converter. The power converter has an energy-storing inductor, and the control circuit comprises a first switch component and a duty cycle control circuit. The first switch component is coupled to the energy-saving inductor to control the energy-storing inductor to store energy. The duty cycle control circuit receives a digital value and a clock signal to count the enable times of the clock signal. When the enable times of the clock signal achieve the digital value, the first switch component is controlled to suspend the energy-storing inductor from storing energy.

According to the control circuit described in the preferred embodiment of the present invention, the power converter is a boost converter, and one end of the energy-storing inductor is coupled to a power supplying end, for receiving an input power. Moreover, the first end of the first switch component is coupled to another end of the energy-storing inductor, the second end of the first switch component is coupled to a common voltage, and the control end thereof is coupled to the duty cycle control circuit. In a preferred embodiment, the control circuit further comprises a second switch component having a first end coupled to another end of the energy-storing inductor, and a second end coupled to the output end of the power converter. In another preferred embodiment of the present invention, the control circuit further comprises a direct current (DC)-DC control module, coupled between the control end of the first switch component and the duty cycle control circuit, and coupled to the control end of the second switch component, so as to control the on/off state of the first switch component and the second switch component.

According to the control circuit described in the preferred embodiment of the present invention, the control circuit further comprises a cross voltage sensing circuit, coupled to the first end of the second switch component, the second end of the second switch component and the DC-DC control module, so as to detect the voltage difference between the first end of the second switch component and the second end of the second switch component, wherein when the voltage difference between the first end of the second switch component and the second end of the second switch component is smaller than or equal to a predetermined voltage, the cross voltage sensing circuit outputs a turn-off control signal to the DC-DC control module, and when the DC-DC control module receives the turn-off control signal, the second switch component is controlled to cut off the circuit between the first end and the second end.

The present invention provides a power converter, which comprises an energy-storing inductor, a first switch component and a duty cycle control circuit. The first switch component is coupled to the energy-storing inductor to control the energy-storing inductor to store energy. The duty cycle control circuit receives a digital value and a clock signal to count the enable times of the clock signal, when the enable times of the clock signal reach the digital value, the switch component is controlled off to suspend the energy-storing inductor from storing energy.

According to the power converter described in the preferred embodiment of the present invention, the power converter is a boost converter, and one end of the energy-storing inductor is coupled to a power supplying end to receive an input power. Further, the first end of the first switch component is coupled to another end of the energy-storing inductor, the second end of the first switch component is coupled to a common voltage, and the control end thereof is coupled to the duty cycle control circuit. In a preferred embodiment, the power converter further comprises a second switch component having a first end coupled to another end of the energy-storing inductor, and a second end coupled to the output end of the power converter. In another preferred embodiment, the power converter further comprises a DC-DC control module, coupled between the control end of the first switch component and the duty cycle control circuit, and coupled to the control end of the second switch component, so as to control the on/off state of the first switch component and the second switch component.

According to the power converter described in the preferred embodiment of the present invention, the power converter further comprises a cross voltage sensing circuit coupled to the first end of the second switch component, the second end of the second switch component and the DC-DC control module, so as to detect the voltage difference between the first end of the second switch component and the second end of the second switch component, wherein when the voltage difference between the first end of the second switch component and the second end of the second switch component is smaller than or equal to a predetermined voltage, the cross voltage sensing circuit outputs a turn-off control signal to the DC-DC control module, and when the DC-DC control module receives the turn-off control signal, the second switch component is controlled to cut off the circuit between the first end and the second end.

In the power converter of the present invention, the current sensing circuit and the resistor formerly used to sense the inductor are replaced by the duty cycle control circuit. The duty cycle control circuit receives a clock signal, and counts the enable times of the clock signal. When the enable times of the clock signal reach a digital value, the on/off state of the switch component is controlled, so as to control the current flowing through the energy-storing inductor, and achieve the objective of controlling the energy stored by the energy-storing inductor. Therefore, the present invention may exactly control the amount of the energy stored by the inductor, reduce the layout area of the chip, reduce the cost, and reduce the power consumption. In addition, the efficiency of the whole power supply may also be increased.

In order to the make aforementioned and other objects, features and advantages of the present invention comprehensible, a preferred embodiment accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional power supply.

FIG. 2 is a circuit block diagram of a power converter using the control circuit of the embodiment of the present invention.

FIG. 3 is a circuit diagram of the power converter and the control circuit of another embodiment of the present invention.

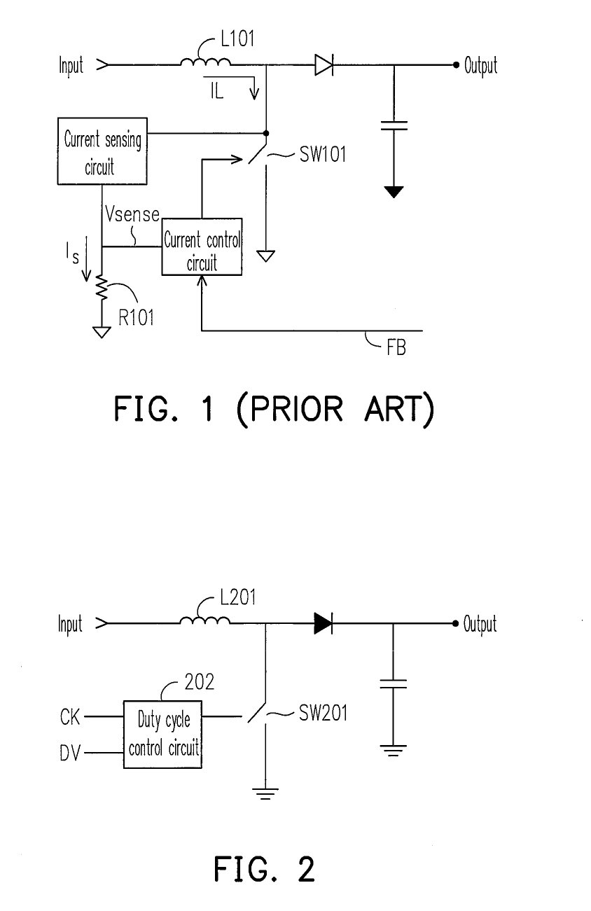

### DESCRIPTION OF EMBODIMENTS

FIG. 2 is a circuit block diagram of a power converter using the control circuit according to the embodiment of the present invention. Referring to FIG. 2, the power converter of the circuit is, for example, a boost converter, and the circuit comprises an energy-storing inductor L201, a switch component SW201 and a duty cycle control circuit 202. The switch component SW201 is coupled to the energy-storing inductor L201 to control the amount of the energy stored by the energy-storing inductor L201. The duty cycle control circuit 202 receives a digital value DV and a clock signal CK, and counts the enable times of the clock signal CK. When the enable times of the clock signal CK reach the digital value DV, the switch component SW201 is controlled to be turned off, and thereby suspending the energy-storing inductor L201 from storing energy.

It should be noted that although a possible mode of the control circuit and the power converter using the control circuit is described in the embodiment, those of ordinary skill in the art should know that the designing manner of the power converter and the control circuit of each manufacture is different, so the application of the present invention is not limited to the possible mode. In other words, so far as the duty cycle control circuit receives a clock signal, and counts the enable times of the clock signal, and when the enable times of the clock signal achieve a digital value, the on/off state of the switch component is controlled, so as to control the energy stored by the energy-storing inductor, the spirit of the present invention is conformed.

Another embodiment of the power converter and the control circuit is given as follows, such that those of ordinary skill in the art may easily implement the present invention.

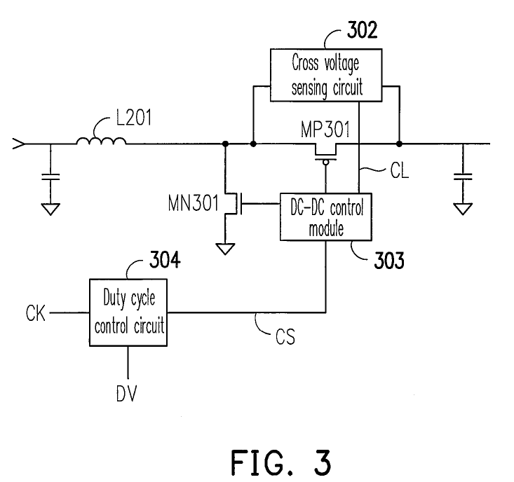

FIG. 3 is a circuit diagram of the power converter and the control circuit according to another embodiment of the present invention. Referring to FIG. 3, the circuit is still, for example, a boost converter, and the circuit comprises an energy-storing inductor L301, an NMOS transistor MN301, a PMOS transistor MP301, a cross voltage sensing circuit 302, a DC-DC control module 303 and a duty cycle control circuit 304. Similarly, the duty cycle control circuit 304 receives a digital value DV and a clock signal CK.

When starting, the DC-DC control module 303 controls the NMOS transistor MN301 to turn it on. Next, the duty cycle control circuit 304 begins to count the clock signal CK, when the enable times of the clock signal CK reach the digital value DV, the duty cycle control circuit 304 outputs a control signal CS. When the DC-DC control module 303 receives the control signal CS, the NMOS transistor MN301 is controlled to be turned off, and the PMOS transistor MP301 is controlled to be turned on, so as to release the energy stored by the energy-storing inductor L301.

When the cross voltage sensing circuit 302 detects that the voltage between the source and the drain of the PMOS transistor MP301 is smaller than a certain predetermined voltage, it means that the energy of the energy-storing inductor L301 is released off, and the cross voltage sensing circuit 302 outputs the turn-off control signal CL. When the DC-DC control module 303 receives the turn-off control signal CL, the PMOS transistor MP301 is controlled to be turned off, and the NMOS transistor MN301 is controlled to be turned on. As such, the cycling control may stabilize the voltage. However, those of ordinary skill in the art should know that the digital value DV may, for example, use the output voltage feedback mechanism or the output current feedback mechanism to achieve the effect of closed loop control, so the detail description is omitted here.

To sum up, in the power converter of the present invention, the current sensing circuit and the resistor formerly used to sense the inductor are replaced by the duty cycle control circuit. The duty cycle control circuit receives a clock signal, and counts the enable times of the clock signal. When the enable times of the clock signal reach a digital value, the on/off state of the switch component is controlled, so as to control the current flowing through the energy-storing inductor, and achieve the objective of controlling the energy stored by the energy-storing inductor. Therefore, the present invention may exactly control the amount of the energy stored by the energy-storing inductor, reduce the layout area of the chip, reduce the cost, and reduce the power consumption. In addition, the efficiency of the whole power supply may also be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control circuit, for controlling a power converter having an energy-storing inductor, comprising:
a first switch component, coupled to the energy-storing inductor, for controlling the energy-storing inductor to store energy; and
a duty cycle control circuit, receiving a digital value and a clock signal, for counting the enable times of the clock signal, wherein when the enable times of the clock signal reach the digital value, the first switch component is controlled to suspend the energy-storing inductor from storing energy.

2. The control circuit as claimed in claim 1, wherein the power converter is a boost converter, and one end of the energy-storing inductor is coupled to a power supplying end, for receiving an input power.

3. The control circuit as claimed in claim 2, wherein the first end of the first switch component is coupled to another end of the energy-storing inductor, the second end of the first switch component is coupled to a common voltage, and the control end thereof is coupled to the duty cycle control circuit.

4. The control circuit as claimed in claim 3, further comprising:
a second switch component, comprising a first end, a second end and a control end, wherein the first end is coupled to another end of the energy-storing inductor, and the second end is coupled to the output end of the power converter.

5. The control circuit as claimed in claim 3, further comprising:
a direct current (DC)-DC control module, coupled between the control end of the first switch component and the duty cycle control circuit, and coupled to the control end of the second switch component, for controlling the on/off state of the first switch component and the second switch component.

6. The control circuit as claimed in claim 3, further comprising:
a cross voltage sensing circuit, coupled to the first end of the second switch component, the second end of the second switch component and the DC-DC control module, for detecting the voltage difference between the first end of the second switch component and the second end of the second switch component,
wherein when the voltage difference between the first end of the second switch component and the second end of the second switch component is smaller than or equal to a predetermined voltage, the cross voltage sensing circuit outputs a turn-off control signal to the DC-DC control module, and when the DC-DC control module receives the turn-off control signal, the second switch component is controlled to cut off the circuit between the first end and the second end.

7. The control circuit as claimed in claim 1, wherein the first switch component is an N type transistor.

8. The control circuit as claimed in claim 3, wherein the second switch component is a P type transistor, and the gate is the control end.

9. A power converter, having an output end, comprising:
an energy-storing inductor;
a first switch component, coupled to the energy-storing inductor, for controlling the energy-storing inductor to store energy; and
a duty cycle control circuit, receiving a digital value and a clock signal, for counting the enable times of the clock signal, wherein when the enable times of the clock signal reach the digital value, the switch component is controlled to suspend the energy-storing inductor from storing energy.

10. The power converter as claimed in claim 9, wherein the power converter is a boost converter, and one end of the energy-storing inductor is coupled to a power supplying end, for receiving an input power.

11. The power converter as claimed in claim 10, wherein the first end of the first switch component is coupled to another end of the energy-storing inductor, the second end of the first switch component is coupled to a common voltage, and the control end thereof is coupled to the duty cycle control circuit.

12. The power converter as claimed in claim 11, further comprising:
a second switch component, comprising a first end, a second end and a control end, wherein the first end is coupled to another end of the energy-storing inductor, and another end is coupled to the output end of the power converter.

13. The power converter as claimed in claim 12, further comprising:
a DC-DC control module, coupled between the control end of the first switch component and the duty cycle control circuit, and coupled to the control end of the second switch component, for controlling the on/off state of the first switch component and the second switch component.

14. The power converter as claimed in claim 12, further comprising:
a cross voltage sensing circuit, coupled to the first end of the second switch component, the second end of the second switch component and the DC-DC control module, for detecting the voltage difference between the first end of the second switch component and the second end of the second switch component,
wherein when the voltage difference between the first end of the second switch component and the second end of the second switch component is smaller than or equal to a predetermined voltage, the cross voltage sensing circuit outputs a turn-off control signal to the DC-DC control module, and when the DC-DC control module receives the turn-off control signal, the second switch component is controlled to cut off the circuit between the first end and the second end.

15. The power converter as claimed in claim 9, wherein the first switch component is an N type transistor.

16. The power converter as claimed in claim 12, wherein the second switch component is a P type transistor, and the gate is the control end.
